(19) United States
(12) Patent Application Publication
(10) Pub. No.: US 2007/0146348 A1
(43) Pub. Date: Jun. 28, 2007

(54) Touch-sensitive faceplate with tactile feedback

(76) Inventor: Jean-Christophe Villain, Ounans (FR)

Correspondence Address: LEON D. ROSEN;FREILICH, HORNBAKER & ROSEN, Suite 1220, 10960 Wilshire Blvd.,, Los Angeles, CA, 90024, US

(21) Appl. No.: 11/711,567

(22) Filed: Feb. 27, 2007

(30) Foreign Application Priority Data
Sep. 9, 2004 (FR) 0409556
Sep. 6, 2005 (EP) PCT/EP05/54379

(51) Int. Cl. G09G 5/00

(52) U.S. Cl. 345/173

(57) ABSTRACT

The invention proposes a touch-sensitive faceplate (18) comprising:
a horizontal upper panel (32);
means (34) for locating the point (P) of contact of a pointing element (30) on the upper face (32s) of the upper panel (32); and
means for detecting at least one control action, independently of the location of the point of contact (P) on the upper face (32s) of the upper panel (32),
characterized in that it comprises means (48, 52) for producing a mechanical impulse of a vertical principal orientation on the upper panel (32), when the value of the pressure (F2) is greater than or equal to the threshold value and that is transmitted to the pointing element (30) to generate a tactile sensation in response to the control action.

### CROSS REFERENCE

Applicant claims priority from PCT application PCT/EP2005/054379 filed 6 Sep. 2005, which claimed priority from French patent application No. 0409556 filed 9 Sep. 2004.

### BACKGROUND OF THE INVENTION

The invention proposes a touch-sensitive faceplate for an electronic apparatus that comprises means for detecting a control action.

The invention proposes more particularly a touch-sensitive faceplate comprising:
a horizontal upper panel with the upper face of which a pointing element is capable of coming into contact; —a supporting frame;
means for locating the point of contact of the pointing element on the upper horizontal face of the upper panel; and
means for detecting at least one control action consisting in applying a pressure, by means of the pointing element, of a value greater than or equal to a predetermined threshold value, independently of the location of the point of contact on the upper face of the upper panel.

Such a touch-sensitive faceplate is a component or subassembly that is particularly designed to be fitted to a portable electronic apparatus such as a laptop computer, a mobile phone, a personal digital assistant called a “PDA”, or any other similar apparatus and it allows a user to control the various functions of the apparatus by moving a pointing element, such as a stylet or else his own finger, on the upper face of the touch-sensitive faceplate and by acting directly on this face.

The touch-sensitive faceplate is usually used in association with a display screen on which information, associated with the operations that the user makes on the touch-sensitive faceplate, is visible.

The touch-sensitive faceplate comprises in particular an upper panel with which the pointing element comes into contact, and means for detecting the position of the point of contact of the pointing element with the upper face of the upper panel.

According to the programming of the apparatus fitted with the touch-sensitive faceplate, various functions of the electronic apparatus are activated according to the actions of the user on the touch-sensitive faceplate by varying in particular the point of contact of the pointing element with the upper face of the upper panel.

According to known examples of the actions of the user, a movement of the point of contact is for example associated with a movement of a cursor on the display screen, or else a tap or a knock of the pointing element on the upper panel corresponds to a control of the implementation of a function of the apparatus, in relation with the position of the cursor on the display screen.

Another action of the user consists in varying the contact of the pointing element by applying more or less pressure to the upper panel.

Document U.S. Pat. No. 5,510,813 describes a touch-sensitive faceplate that comprises means for measuring the pressure applied by the pointing element to control the operation of the apparatus.

However, such a touch-sensitive faceplate does not comprise any means for returning to the user any return sensation of his actions.

It is not therefore truly a “touch-sensitive” faceplate, but rather a “sensitive” faceplate due to the fact that it is capable only of receiving actions from the user.

To return information to the user, it is a known practice to emit via the electronic apparatus an audible or visual signal at the time of the control action. However, according to the conditions of use of the electronic apparatus, for example in a noisy environment or else when there is a great deal of light, such an audible or visual signal is not perceptible.

In order to produce a tactile sensation for the user, certain touch-sensitive faceplates comprise one or more actuators that cause the upper panel to vibrate.

Document EP-A-0.901.229 describes such a touchsensitive faceplate in which the means for detecting the position of the point of contact of the pointing element are capable of measuring the pressure of the pointing element, and are also capable of causing a vibration of the upper panel.

The vibration of the upper panel is generated to inform the user that a function of the apparatus has been executed.

The object of the invention is to propose a touch-sensitive faceplate that is capable of generating tactile information when the user exerts the control action.

### SUMMARY OF THE INVENTION

For the above purposes, the invention proposes a touch-sensitive faceplate of the type described above, characterized in that it comprises means for producing a mechanical impulse of a vertical principal orientation on the upper panel, when the value of the pressure is greater than or equal to the threshold value and that is transmitted to the pointing element to generate a tactile sensation in response to the control action.

The sensation thus generated confirms to the user that he has effectively pressed on the upper panel, in the manner of a “click” sensation produced when the user presses a button or a key of a keyboard.

Thus, the tactile sensation generated by the touchsensitive faceplate according to the invention may be perceived by the user irrespective of the outside conditions.

According to other features of the invention:
the mechanical impulse is generated by a brief downward movement of the upper panel relative to the supporting frame under the effect of the control action;
the touch-sensitive faceplate comprises a single element forming a disengageable stop of the upper panel in a high position relative to the supporting frame that is capable of changing state under the effect of the control action to allow the upper panel to move generally downward relative to the supporting frame;
the disengageable stop consists in a concave element, that is arranged vertically between a lower horizontal face of the upper panel and a horizontal face opposite the supporting frame and that is capable of collapsing by elastic deformation when the value of the pressure of the pointing element is greater than or equal to the threshold value;
the disengageable stop is arranged generally in line with the center of the upper panel;
the upper panel is partly in upward abutment against the lower horizontal face of an upper horizontal wall of the frame under the effect of the control action and when the point of contact is offset horizontally relative to the disengageable stop;
the upper panel is partly in abutment against one of at least three bearing points belonging to said lower face and arranged in a triangle, the disengageable stop being situated inside this triangle;
the touch-sensitive faceplate comprises means for returning the upper panel to a high rest position;
the touch-sensitive faceplate comprises an electronic actuator that is capable of generating the mechanical impulse between the upper panel and the supporting frame;
the electronic actuator consists in a piezoelectric actuator that is arranged beneath a lower horizontal face of the upper panel;
the detection means comprise a single sensor that is compressed between the upper panel and a support plate of the upper panel;
the single sensor consists in an electric commutator that is capable of opening or closing an electric circuit under the effect of the control action;
the disengageable stop and the detection means consist in a single electronic commutator that is arranged between the location means and the frame;
the single sensor consists in a pressure sensor that is capable of determining the value of the pressure of the pointing element;
the location means and the detection means consist in a single detection device, particularly of the resistive type, that covers the lower horizontal face of the upper panel;
the location means comprise electric switches that are distributed horizontally beneath the lower face of the upper panel, and each of which is associated with a predefined portion of the upper face of the upper panel;
the upper panel is made of an elastically deformable material, and the detection means are arranged on the upper horizontal face of an intermediate support plate;
the horizontal upper face of the upper panel comprises a series of bosses;
the support plate supports a series of electric connection elements that are distributed evenly along the peripheral edge of the support plate;
the touch-sensitive faceplate comprises means for displaying information selectively on the upper panel;
the touch-sensitive faceplate comprises a display screen arranged beneath the upper panel;
the touch-sensitive faceplate comprises a layer of ink printed on the lower face of the upper panel, and a light-emitting film that covers the printed ink layer, that is capable of illuminating selectively certain zones of the printed ink layer;
the detection means are capable of detecting different control actions, each of which consists in applying by means of the pointing element a pressure on the upper face of the upper panel with a value greater than or equal to an associated threshold value;
the touch-sensitive faceplate comprises means for generating a mechanical impulse each time one of the control actions has been detected by the detection means.

The invention also proposes an arrangement for the mounting of a touch-sensitive faceplate on a horizontal upper face of an electronic component-carrying board, characterized in that the upper panel, the location means, the means for detecting the control action and the means for generating the mechanical impulse form a subassembly that is mounted and attached on the upper face of the electronic component-carrying board by elastic interlocking.

According to other features of the arrangement according to the invention:
the subassembly is mounted on the upper face of the component-carrying board by means of an intermediate board;
the intermediate board carries a connector for the electrical connection of the touch-sensitive faceplate to the electronic component-carrying board.

Other features and advantages of the invention will appear on reading the following detailed description, for the understanding of which reference will be made to the appended figures in which:

### BRIEF DESCRIPTION OF THE DRAWINGS

FIG. 1 is a schematic representation in perspective of a portable electronic apparatus that comprises two parts articulated relative to one another and of which the lower part supports a touch-sensitive faceplate according to the invention;

FIG. 2 is a section along a vertical longitudinal plane of the touch-sensitive faceplate that is fitted to the apparatus represented in FIG. 1 in the rest state;

FIG. 3 is a view similar to that of FIG. 2 in which a pressure corresponding to a control action is exerted on the upper panel of the touch-sensitive faceplate;

FIG. 4 is a view similar to that of FIG. 2 that comprises a piezoelectric element for detecting the pressure and for generating the mechanical impulse;

FIG. 5 is an exploded schematic isometric representation of a touch-sensitive faceplate according to another aspect of the invention, in which the point of contact is located by means of several electric contacts;

FIG. 6 is a section along a vertical longitudinal plane of the arrangement for mounting the touch-sensitive faceplate represented in FIG. 5 on an electronic component-carrying board, according to the invention, and in which the touchsensitive faceplate is shown before it is mounted;

FIG. 7 is a view similar to that of FIG. 6, in which the touch-sensitive faceplate is mounted on the electronic component carrying board;

FIG. 8 is a view similar to that of FIG. 7, in which the touch-sensitive faceplate is mounted on the electronic component carrying board by means of an intermediate board;

FIG. 9 is a view similar to that of FIG. 8, in which the intermediate board supports an electronic chip and a connector for connection with the electronic component-carrying board.

### DESCRIPTION OF THE PREFERRED EMBODIMENTS

For the description of the invention, the vertical, longitudinal and transverse orientations will be adopted in a nonlimiting manner according to the V, L, T indication shown in the figures.

To make the description and the claims easier to understand, the terms “upper” and “lower” will also be adopted with reference to the vertical orientation V indicated in the figures.

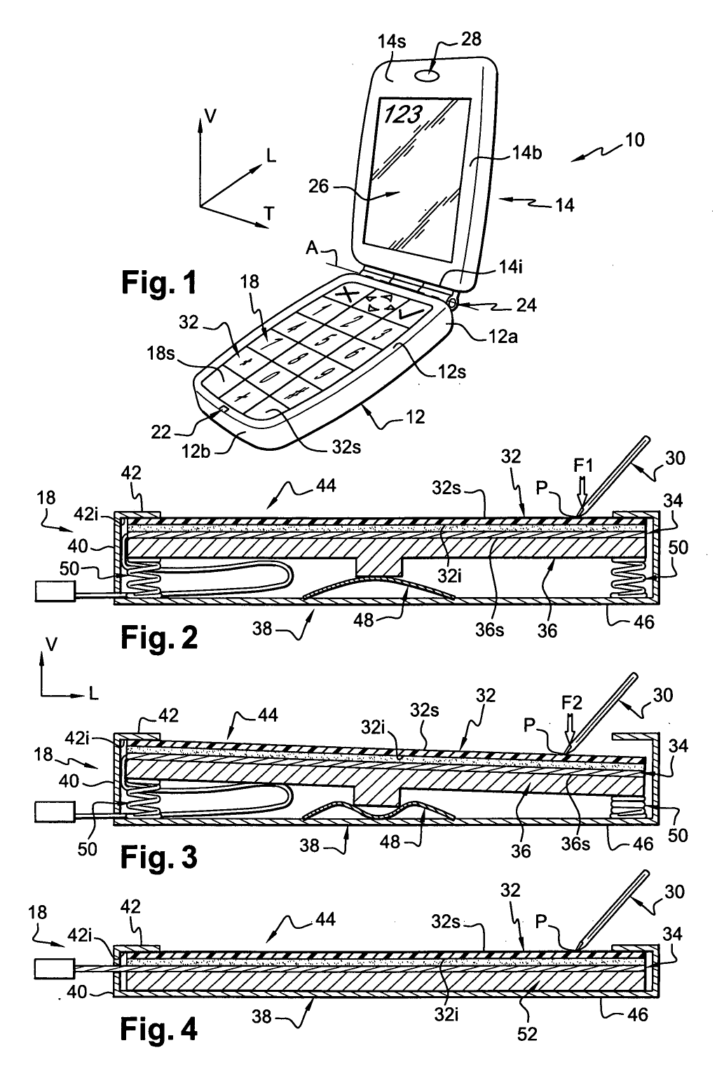

The orientation from front to rear will also be used as being the longitudinal direction from left to right with reference to FIG. 1.

In the following description, identical, similar or analogous elements will be indicated by the same reference numbers.

FIG. 1 shows a portable electronic apparatus 10 that here is a mobile phone of the type called “clamshell”, that is to say that consists of two structural elements 12, 14 that each have generally the shape of a rectangular plate.

The two structural elements 12, 14 are articulated relative to one another about a transverse axis A between a folded or closed position (not shown) in which the two structural elements 12, 14 are side by side extending horizontally longitudinally and an extreme unfolded or open position shown in FIG. 1, in which the two structural elements 12, 14 delimit an angular sector.

A first lower structural element 12 extends longitudinally, generally horizontally. It supports on its upper face 12s a touchsensitive faceplate 18 for controlling the mobile phone 10. It also comprises, at its rear longitudinal end 12b, a microphone 22 allowing the user to speak to his interlocutor, and at its front longitudinal end 12a, means 24 for articulating the second structural element 14 about the transverse axis A of articulation.

The second upper structural element 14 here extends in a generally vertical transverse plane and it is articulated at its lower end 14i relative to the first structural element 12 about the transverse axis A of articulation. It supports a display screen 26 on a rear face 14b.

Finally, the second structural element 14 supports, at a free upper end 14s, a speaker 28 allowing the user of the telephone 10 to hear the voice of his interlocutor.

It will be understood that the invention is not limited solely to this type of portable electronic apparatus comprising two structural elements articulated relative to one another and that the touch-sensitive faceplate 18 may also be used in an electronic apparatus 10 comprising a single structural element.

In addition, it will also be understood that the invention is not limited to use in a mobile phone and that the electronic apparatus 10 comprising the touch-sensitive faceplate 18 according to the invention may also consist in another type of apparatus such as a laptop computer or a personal assistant, commonly called a “PDA”.

As can be seen in FIGS. 2, 3 and 4, to control the various functions of the electronic apparatus, the user uses the free end of a pointing element 30 that is here a stylet but that may also be a finger of the user, by placing it in contact with the upper face 18s of the touch-sensitive faceplate 18.

In response to this contact of the pointing element 30, an electronic control device (not shown) of the electronic apparatus 10 exerts a predefined action, such as for example the display of a cursor on the screen 26, in a position associated with the position of contact of the pointing element 30 on the upper face 18s of the touch-sensitive faceplate 18.

There are various possible control actions that the user makes by means of the pointing element 30.

For example, a horizontal translation of the pointing element 30 on the upper face 18s of the touch-sensitive faceplate 18 is interpreted as the desire of the user to cause a movement of the cursor displayed on the screen 26, or else a brief interruption of contact of the pointing element 30 with the upper face 18s of the touch-sensitive faceplate 18 is interpreted as the selection of a function of the apparatus 10.

The touch-sensitive faceplate 18 is also capable of detecting a control action that consists in applying a pressure on its upper face 18s, by means of the pointing element 30, and the electronic control device executes a function of the apparatus 10 in relation with the control action that has been detected.

In the following description, the formula “control action” will be used to indicate the action of the user consisting in applying a pressure on the upper face 18s of the touch-sensitive faceplate 18 whose “useful” component is greater than or equal to a threshold value.

As can be seen in greater detail in FIG. 2 and following, the touch-sensitive faceplate 18 comprises a horizontal upper panel 32 whose horizontal upper face 32s is the upper face 18s of the touch-sensitive faceplate 18.

The touch-sensitive faceplate 18 also comprises means 34 for locating the position of the point of contact P of the pointing element 30 with the upper face 32s of the upper panel 32.

The location means 34 are of a known type, for example of the resistive type. Their structure and operation being known, they will not be described in greater detail in the present description of the invention.

The location means 34 are in the form of a thin strip which extends horizontally beneath the upper panel 32, covering the horizontal lower face 32i of the upper panel 32.

The upper panel 32 and the location means 34 are mounted on the upper face 36s of a horizontal support plate 36 which confers a generally flat shape on the location means 34 and the upper panel 32.

The touch-sensitive faceplate 18 comprises a peripheral supporting and mounting frame 38 that comprises a cylindrical wall 40 with a vertical principal axis and that extends around the upper panel 32, the location means 34 and the support plate 36 and whose generatrix of the cylindrical wall has substantially the same shape as the peripheral edge of the support plate 36.

The frame 38 also comprises a horizontal upper wall 42 that extends above the upper panel 32 so that the upper panel 32 is in vertical upward abutment against the lower face 42i of the upper wall 42.

The upper wall 42 is open at its center and the central opening 44 thus formed allows access to the upper face 32s of the upper panel 32 by means of the pointing element 30.

The frame 38 also comprises a horizontal lower wall 46 that is situated beneath the upper panel 32, the location means 34 and the support plate 36.

The frame 38 also comprises means (not shown) of mounting in the electronic apparatus 10.

As has been said above, the touch-sensitive faceplate 18 comprises means for detecting the control action that the user exerts by means of the pointing element 30.

The means for detecting the control action are formed so as to detect the control action independently of the location of the point of contact P with the upper face 32s of the upper panel 32.

This allows the user to keep the pointing element 30 in one position relative to the upper panel 32 when he exerts the control action.

It is thus possible to implement a function of the electronic apparatus 10 that is directly associated with the position of the point of contact P detected by the location means 34.

The touch-sensitive faceplate 18 is formed so as to generate a tactile sensation in response to the control action, that is perceived by the user.

For this, and according to the invention, the touch-sensitive faceplate 18 comprises means for generating a mechanical impulse on the upper panel 32 when the value of the pressure generated during the control action is greater than or equal to the predetermined threshold value.

According to a first embodiment represented in FIGS. 1 and 2, the mechanical impulse is generated by a brief downward movement of the upper panel 32 relative to the frame 38 under the effect of the control action.

For this, the assembly formed by the upper panel 32, the location means 34 and the support plate 36 is mounted so as to be movable relative to the supporting frame 38 between a high rest position represented in FIG. 2 and one or more low positions, whereof an example of a low position is represented in FIG. 3, when the user exerts a pressure on the upper panel 32 whose value is greater than the predetermined threshold value.

For the movement of this assembly to be sufficiently brief, the touch-sensitive faceplate 18 comprises a disengageable or retractable element 48 that forms a stop of the support plate 36 in the high rest position and that is capable of changing state under the effect of the control action.

In its disengaged state resulting from the control action, the disengageable element 48 no longer forms a stop of the support plate 38, thereby allowing it to move generally downward.

The disengageable element 48 here has the shape of a dome, that is to say that it is of concave shape open downward and has a vertical principal axis. It is arranged between the support plate 36 and the lower wall 46 of the supporting frame 38, and it is capable of collapsing by elastic deformation when the value of the pressure is greater than the threshold value, as can be seen in FIG. 3. The disengageable element 48 then suddenly changes state in an operation also called “collapsing”.

Thus, as can be seen in FIG. 2, when the value of the pressure exerted on the upper face 32s of the upper panel 32 is less than the threshold value, as has been shown by the arrow F1, the pressure is not sufficient to cause the change of state of the disengageable element 48.

Consequently, the assembly formed by the upper panel 32, the location means 34 and the support plate 36 is kept by the disengageable element 48 in the high rest position.

On the other hand, as has been represented in FIG. 3, when the user exerts on the upper face 32s a greater pressure F2, whose value is greater than the threshold value, the disengageable element 48 deforms and changes state, allowing the assembly formed by the upper panel 32, the location means 34 and the support plate 36 to move suddenly downward.

This sudden movement of the movable assembly is transmitted to the user by the pointing element 30 and is felt by the user as a tactile sensation representative of the control action that he has just performed.

When the user ceases to apply the pressure corresponding to the control action, the movable assembly formed by the upper panel 32, the location means 34 and the support plate 36 is elastically returned to the high rest position represented in FIG. 2, and the disengageable element 48 returns to its stable rest state.

According to a preferred embodiment of the invention, the elastic return is performed by return means 50, that here are helical springs.

As a variant not shown, the elastic return is provided by the disengageable element 48 itself.

During the return of the movable assembly to its high rest position, the disengageable element 48 again changes state to resume its initial form, and it then exerts on the support plate 36 a brief force oriented upward. This new impulse thus generated by the disengageable element 48 reproduces another tactile sensation that is perceived by the user as the confirmation of the end of the control action.

Here, the disengageable element 48 is situated generally in line with the geometric center of the upper panel. This positioning of the disengageable element makes it possible to limit the difference of amplitude of the pressure to be applied to the upper panel 32 to cause the deformation of the disengageable element, depending on the location of the point P on the upper face 32s of the upper panel 32.

The deformation of the disengageable element 48 when the user exerts the control action is also promoted by the fact that the peripheral edge of the assembly—formed by the upper panel 32, the location means 34 and the support plate 36—is in upward abutment against the lower horizontal face 42i of the upper horizontal wall 42 of the frame.

Thus, the assembly formed by the upper panel 32, the location means 34 and the support plate 36 cannot pivot about the disengageable element 48 during the control action, and when the point of contact P is not situated in line with the disengageable element.

Furthermore, the upper horizontal wall 42 is here in the shape of an annular strip that covers the totality of the peripheral edge of the assembly formed by the upper panel 32, the location means 34 and the support plate 36.

However, it will be understood that the upper wall 42 may also be interrupted, and even comprise for example only three horizontal pressure pads that are distributed along the peripheral edge of the assembly formed by the upper panel 32, the location means 34 and the support plate 36 so as to retain the assembly formed by the upper panel 32, the location means 34 and the support plate 36.

The disengageable element 48 is then situated inside the triangle thus defined by the three horizontal pressure pads.

FIG. 4 shows a variant embodiment of the invention according to which the upper panel 32 is immobile when the user exerts the control action.

According to this variant, the mechanical impulse is generated by an actuator 52, which consists here of an actuator of the piezoelectric type, that is arranged between the location means 34 and the lower wall 46 of the frame 38.

In addition, the actuator 52 extends horizontally over a surface area that is substantially identical to the surface area of the upper panel 32, so that the user feels the impulse irrespective of the position of the point of contact P on the upper face 32s of the upper panel 32.

This actuator 52 is controlled by the electronic device for controlling the electronic apparatus 10, and it is used when the control action has been detected.

The means for detecting the control action comprise a single sensor that is arranged beneath the upper panel 32 and that is formed to detect the control action, irrespective of the location of the point of contact P of the pointing element 30 on the upper face 32s of the upper panel 32.

According to a first embodiment, the single sensor for detecting the control action consists of an electric commutator that is capable of opening or closing an electric circuit under the effect of the control action.

According to a first preferred embodiment of this commutator, the latter is associated with the disengageable element 48 so as to form a single electric commutator that is capable of simultaneously generating the mechanical impulse and a signal that is an item of electronic information, when the disengageable element 48 changes state under the effect of the control action.

According to another embodiment of the single sensor, the latter is capable of measuring the value of the pressure exerted by the user on the upper face 32s of the upper panel 32, by means of the pointing element 30.

This single sensor then transmits to the electronic device for controlling the electronic apparatus 10 an item of information representing the value of the pressure.

The electronic control device then compares the value of the pressure thus measured or estimated with the threshold value to determine whether the action exerted by the user is effectively a control action or not.

For this, the single sensor consists in a pressure sensor that is arranged beneath the upper panel 32.

According to a preferred aspect of this pressure sensor, it forms a portion of a detection device that also comprises the location means.

The detection device then consists in a single device of a known type, for example of the resistive type, that covers the lower horizontal face 32i of the upper lower panel.

According to another aspect of the pressure sensor, the latter is formed by the piezoelectric actuator 52 represented in FIG. 4.

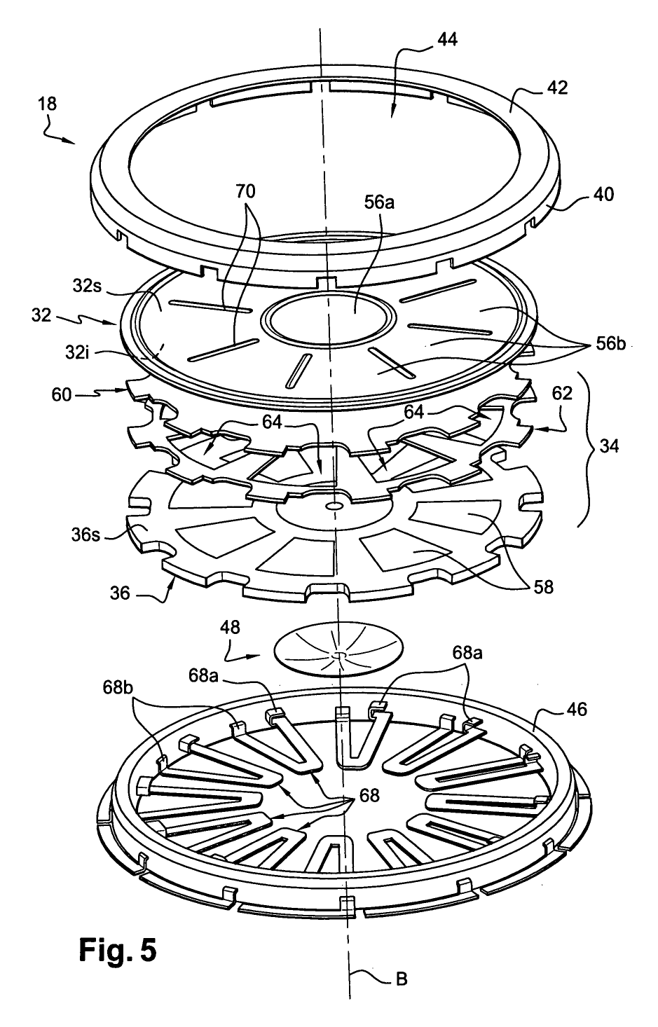

FIG. 5 and following show a variant embodiment of the touch-sensitive faceplate 18 according to the invention whereby the location means 34 comprise a series of electric switches 54 that are distributed horizontally under the upper panel 32, so that each electric switch 54 is associated with a predefined portion or zone 56a, 56b of the upper panel 32.

Furthermore, according to this variant embodiment, the touch-sensitive faceplate 18 is circular in shape with a vertical and central principal axis B.

The upper panel 32 thus comprises a central portion 56a, circular in shape and coaxial with the axis B of the touch-sensitive faceplate 18, and peripheral portions 56b, here eight in number, that are distributed about the central portion 56a.

Consequently, the location means 34 comprise a central switch 54 associated with the central portion 56a of the upper panel 32, and eight peripheral switches 54 each associated with one of the peripheral portions 56b.

Each of the switches 54 comprises a layer of conductive material 58 that is printed on the upper face 36s of the support plate 36 and a film 60 that is arranged above and at a distance from the layer 58 of conductive material.

The film 60 is made of an electrically conductive material and it is capable of coming into contact with the layer 58 of conductive material when the pointing element 30 comes into contact with the upper face 32s of the upper panel 32.

Here, the location means comprise a single film 60 that extends horizontally above the layers 58 of conductive material of all the switches 54.

The conductive film 60 is kept at a distance from the layers 58 of conductive material by a spacer 62 arranged vertically between the support plate 36 and the conductive film 60.

The spacer 62 comprises openings or windows 64 that are situated in line with the layers 58 of conductive material, and that are traversed by a portion of the conductive film 60 when it comes locally into contact with the layers 58.

When the pointing element 30 comes into contact with the upper panel 32, the film 60 deforms elastically downward and then comes into contact with the layer 58 situated in line with the point of contact P, closing an electric circuit.

This deformation of the film 60 is accompanied by a similar deformation of the upper panel 32 that is for this purpose made of an elastically deformable material.

Here, the control action is detected and the mechanical impulse is generated simultaneously by the disengageable element 48, that here is concave in shape open upward and coaxial with the axis B of the touch-sensitive faceplate 18.

The disengageable element 48 comprises a layer made of electrically conductive material, that is capable of coming into contact with another layer of conductive material (not shown) that is printed on the lower face 36i of the support plate 36, when the disengageable element 48 changes state under the effect of the control action.

The location means 34 and the means for detecting the control action are connected to the electronic device for controlling the electronic apparatus 10 by electric connection elements 68 that consist here of folded metal sheets.

To generate an additional tactile effect, the touch-sensitive faceplate 18 comprises means whereby the user feels a determined sensation when he moves the pointing element 30 over the upper face 32s of the upper panel 32.

This sensation is obtained by means of bosses 70 that protrude upward relative to the upper face 32s of the upper panel 32.

According to a preferred embodiment, the bosses 70 are arranged so that they each delimit portions 56a, 56b of the upper panel 32.

Thus, when the user moves the pointing element 30 over the upper face 32s of the upper panel 32, the contact of the pointing element 30 with each of the bosses 70 is felt by the user, which notifies him that the point of contact P is moving from one portion 56a, 56b of the upper panel 32 to another.

Furthermore, when the pointing element 30 is the finger of the user, the user may directly deduce the position of the point of contact P on the upper face 32s of the upper panel 32 by the tactile sensation that he perceives when “passing over” a boss.

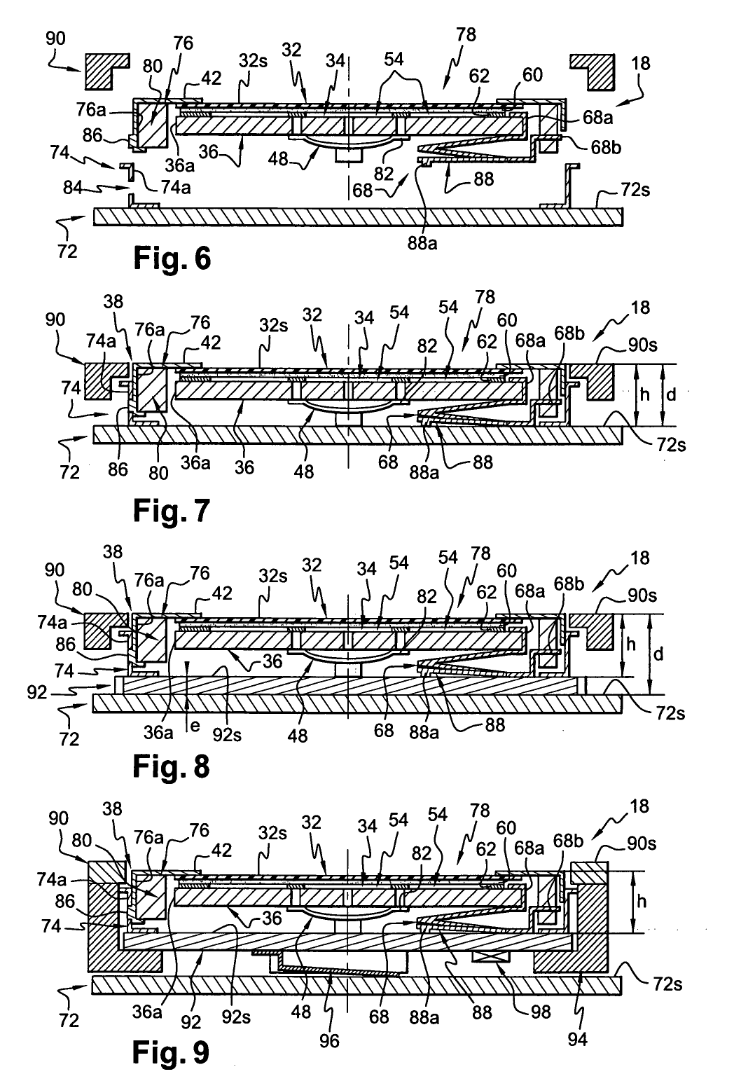

FIGS. 6 to 9 show an arrangement for the mounting of the touch-sensitive faceplate 18 according to the invention on an electronic component-carrying board 72 of the electronic apparatus 10.

According to one aspect of the invention, the upper panel 32, the location means 34, the support plate 36 and the disengageable element 48 are fixedly attached together so as to form a subassembly 78 that is attached to the electronic component-carrying board 72 by elastic interlocking.

As can be seen in FIGS. 6 and 7, the supporting frame 38 is formed in two parts, and it comprises a lower framework 74 that is attached to the horizontal upper face 72s of the electronic component-carrying board 72, and an upper framework 76 that is connected to the subassembly 78

The upper framework 76 thus comprises the horizontal upper wall 42 of the frame 38 against the lower face 42i of which the subassembly 78 is held pressing vertically upward by means of the electric connection elements 68.

Accordingly, each of the electric connection elements 68 consists in a metal sheet that is elastically deformable, of which a first end 68a is connected to the support plate 36 and of which the second end 68b is attached to the upper framework 76 by means of an intermediate annular element 80.

Here, the first end 68a of the electric connection element 68 forms a C-shaped hook that is mounted about the outer peripheral edge 36a of the support plate 36.

The disengageable element 48 comprises a peripheral collar 82 for its attachment to the lower face 36i of the support plate 36.

Thus, the electric connection elements 68 also make the mechanical connection of the upper panel 32, the location means 34 and the support plate 36 with the upper framework 76 and they make it possible to return the upper panel 32 to its high rest position after the user has exerted the control action on the touchsensitive faceplate 18.

As has been said above, the subassembly 78 is mounted on the electronic component-carrying board 72 by elastic interlocking.

According to the invention, the lower framework 74 and the upper framework 76 support complementary elements that perform this elastic interlocking.

These complementary elements have been represented here by an orifice 84 made in a vertical wall 74a of the lower framework 74, into which a matching pin 86 is received that protrudes horizontally outward from the upper framework 76 relative to a vertical wall of the upper framework 76.

The vertical wall 74a of the lower framework and/or the vertical wall 76a of the upper framework is capable of deforming elastically during mounting, so as to collapse to allow the pin 86 to move downward, then this wall 74a, 76a returns elastically to position when the pin 86 is situated in line with the orifice 84, thus attaching the subassembly 78 to the lower framework 74 by elastic interlocking.

According to a preferred embodiment, the lower framework 74 is attached to the electronic component-carrying board 72 by brazing or soldering.

This attachment mode is first carried out by applying the pad to be brazed on the upper face 72s of the electronic component-carrying board 72, then placing the lower framework 74 on the upper face 72s of the electronic component-carrying board 72, covering the layer of brazing pad.

Finally, the definitive attachment is achieved by passing the electronic component-carrying board and the lower framework 74 in an oven heated to a temperature defined to achieve first a melting of the brazing paste that is distributed evenly over the electronic component-carrying board 72 and the lower framework 74, then a hardening of the brazing paste.

The oven temperature that is necessary to obtain the melting of the brazing paste is relatively high, and it may damage certain components of the touch-sensitive faceplate 18.

Thus, assembling the upper panel 32, the location means 34, the support plate 36 and the disengageable element 48 in a single subassembly 78 that is mounted on the electronic component-carrying board 72 by elastic interlocking makes it possible to mount the subassembly 78 after the electronic component-carrying board 72 has been placed in the oven.

Therefore, it is possible to use any type of material to produce the upper panel 32, the location means 34, the support plate 36 and the disengageable element 48, particularly heat sensitive plastics.

According to another aspect of the mode of mounting the touch-sensitive faceplate 18 on the electronic component-carrying board 72, during the mounting of the subassembly 78 on the upper face 72s of the electronic component-carrying board 72, the touch-sensitive faceplate 18 is simultaneously electrically connected to the electronic component-carrying board 72.

For this, each of the electric connection elements 68 comprises a flexible contact sheet 88 whereof a free end 88a is capable of pressing against an associated electric track (not shown) of the upper face 72s of the electronic component-carrying board 72.

This contact sheet 88 is formed so that it is elastically prestressed upward when the touch-sensitive faceplate 18 is mounted on the electronic component-carrying board 72 to exert an elastic pressure of contact against the associated electric track.

This makes it possible on the one hand to ensure a good quality electric contact between the contact sheet 88 and the electric track and, on the other hand, to absorb any variations of dimensions and form of the electronic component-carrying board 72 or of the lower framework 74 that are due to the mode of attaching the lower framework 74 to the electronic component carrying board 72.

The mounting of the touch-sensitive faceplate 18 according to the invention by grouping all the components in a subassembly 78 makes it possible to manufacture the subassembly 78 by mass production and independently of the rest of the electronic apparatus 10; similarly the display screen is also manufactured independently of the other components.

However, the dimensional specifications of two different items of electronic apparatus 10 may be nonidentical.

So, for example, the distance “d” between the upper face 90s of the outer casing 90 of the apparatus 10 and the electronic component-carrying board 72 is usually different between two different items of electronic apparatus 10.

However, the height “h” of the touch-sensitive faceplate 18 according to the invention is always the same because of its being mounted according to a single method, which requires keeping the upper face 32s of the upper panel 32 at the same level as the upper face 90s of the outer casing 90 of the electronic apparatus 10.

Accordingly, FIG. 8 shows a variant embodiment of the arrangement for mounting the touch-sensitive faceplate 18 according to the invention on the upper face 72s of the electronic component-carrying board 72 that comprises an intermediate board 92 that is interposed between the touch-sensitive faceplate 18 and the electronic component-carrying board 72.

The thickness “e” of this intermediate board 92 is chosen according to the distance “d” between the upper face 90s of the outer casing 90 of the apparatus 10 and the electronic component-carrying board 72 and according to the height “h” of the touch-sensitive faceplate 18 so that the upper face 32s of the upper panel 32 is flush with the upper face 90s of the outer casing 90.

The touch-sensitive faceplate 18 is then attached to this intermediate board 92 by elastic interlocking, as has been described above, that is to say that the lower framework 74 of the supporting frame 38 is attached to the upper face 92s of the intermediate board 92.

In addition, the intermediate board 92 comprises means (not shown) for electrically connecting the electric connection elements 68 of the touch-sensitive faceplate 18 to the associated tracks of the electronic component-carrying board 72.

According to yet another variant embodiment of the touchsensitive faceplate 18 according to the invention, the subassembly 78 forms an electronic module with the intermediate board 92.

The subassembly 78 is mounted on the intermediate board 92 by elastic interlocking as described above, and the module thus formed is mounted directly on the frame 94 of the structural element 12 of the electronic apparatus 10.

The module also comprises an electronic connector 96 to connect it electronically to the electronic component-carrying board 72.

This mounting of the touch-sensitive faceplate 18 in module form allows the assembler of the apparatus 10 to use a module comprising the touch-sensitive faceplate according to the invention, or else to use another module comprising different means for controlling the apparatus 10, such as for example a conventional keyboard.

This type of mounting adds a possibility of modularity of the apparatus 10, by making it possible to use different control means for one and the same apparatus, without having to change the other components of the apparatus 10 such as the electronic component-carrying board 72 or the structural element 12.

However, the difference of operation between a touchsensitive faceplate 18 according to the invention and a conventional keyboard means that the information that is transmitted via the connector 96 to the electronic component carrying board 72, and therefore to the electronic device for controlling the apparatus 10, is different depending on whether the module comprises a touch-sensitive faceplate 18 or a conventional keyboard.

For the control information that is transmitted via the connector 96 to be common to all the modules mounted on the electronic component-carrying board 72, the module according to the invention comprises an electronic chip or a microprocessor 98 that is mounted on the intermediate board 92 and that connects the subassembly 78 to the connector 96.

This electronic chip 98 is programmed to analyze and interpret the control information originating from the touchsensitive faceplate 18 or from the electronic control device, in order to convert it into information or signals for controlling the electronic control device or the touch-sensitive faceplate 18 respectively.

This conversion of the control information by the processor 98 therefore makes it possible to have unique programming of the electronic device for controlling the apparatus 10, irrespective of the module used, whether it comprises a touch-sensitive faceplate 18 according to the invention or other means of controlling the apparatus 10.

In addition, it allows the use of a “standard” connection between the connector 96 and the electronic component-carrying board 72.

According to yet another aspect of the invention, the touchsensitive faceplate 18 comprises information display means that are variable and that depend in particular on the state of operation of the electronic apparatus 10.

According to a first embodiment, these display means consist in a display screen, for example a display screen of the liquid crystal type, known by the acronym “LCD”, or of the organic light-emitting diode type, known by the acronym “OLED”.

According to another embodiment of the display means, they comprise a layer representing various information that is printed on the lower face 32i of the upper panel 32 and a light-emitting film that is arranged between the upper panel 32 and the location means 34, covering the printed layer.

The light-emitting film is controlled by the electronic device for controlling the electronic apparatus 10 to illuminate or not illuminate the printed layer, so that the information is visible or not visible to the user.

For example, here, the information consists of a symbol or a logo that is illuminated when the electronic apparatus 10 is switched on.

According to a variant embodiment, the light-emitting film is formed so as to selectively illuminate certain zones of the printed layer, and the electronic control device is capable of controlling the electronic apparatus 10 so that it illuminates the information that the user must see.

For example, the information to be displayed is alphanumeric characters and symbols such as the hash “#” and the asterisk “*”, that are combined in two character groups of which a first group comprises the ten numeric characters of the decimal system and the symbols, and the second group comprises the letters of the alphabet.

The characters of each group are distributed over the surface of the upper panel 32, as can be seen in FIG. 1 for the first group of characters.

The light-emitting film is controlled by the electronic control device so that it selectively illuminates the characters of one or other of the two groups of characters, or none of the characters.

Thus, the user can see only the characters of the first group, in which case the touch-sensitive faceplate has generally the aspect of a conventional numeric keypad, as has been shown in FIG. 1, or else the user can see only the characters of the second group.

Furthermore, the electronic control device is programmed so that, for one and the same location of the point of contact P on the upper face 32s of the upper panel 32, the operation of the apparatus is different depending on whether the characters of the first group or of the second group are illuminated.

The light-emitting film may also be controlled so as to constantly illuminate certain characters or symbols that are common to the two groups of characters. This is particularly the case for symbols associated with a confirmation function or a cancellation function.

This selective illumination of zones of the printed layer makes it possible to reduce the elements visible to the user, which simplifies the use of the electronic apparatus 10.

Furthermore, the characters of each group may also be oriented differently so that, when the characters of the first group are displayed, the touch-sensitive faceplate 18 may be used in a portrait mode, that is to say with its great length generally vertical relative to the user, as has been shown, for example, in FIG. 1.

On the other hand, when the characters of the second group are displayed, the touch-sensitive faceplate 18 may be used in a landscape mode, in the manner of a computer keyboard, that is to say an orientation of the touch-sensitive faceplate 18 for which the great length of the touch-sensitive faceplate 18 is generally transverse relative to the user.

The touch-sensitive faceplate 18 according to the invention that has just been described comprises means for detecting a single control action. However, it will be understood that the touch-sensitive faceplate 18 according to the invention may comprise means for detecting several control actions.

Each of these control actions then consists in applying a pressure to the upper face 18s of the touch-sensitive faceplate 18, whose associated threshold value is different from the threshold value associated with another control action.

It is therefore possible for the user to exert several control actions successively, by progressively increasing the pressure of the pointing element 30.

In addition, the touch-sensitive faceplate 18 according to the invention comprises means for producing a mechanical impulse each time one of the control actions has been detected by the detection means.

The touch-sensitive faceplate 18 according to the invention has been described as being of rectangular shape and covering a large portion of the upper face 12s of the first structural element of the electronic apparatus 10, as has been shown in FIGS. 1 to 4, or else of circular shape, as shown in FIG. 5.

However, it will be understood that the invention is not limited to these embodiments of the invention and that the touchsensitive faceplate 18 may be of various shapes and/or dimensions.

In addition, an electronic apparatus 10 has been described that comprises only one touch-sensitive faceplate 10. It will also be understood that an electronic apparatus may comprise several touch-sensitive faceplates 18 according to the invention.

For example, the electronic apparatus 10 comprises an additional touch-sensitive faceplate 18 according to the invention whose dimensions are reduced relative to the dimensions of the electronic apparatus 10.

This touch-sensitive faceplate 18 with reduced dimensions is for example arranged close to the display screen 26, preferably along a lateral edge of the screen 26. It then makes it possible to control the display on the screen 26 easily, such as for example the scrolling of a list, or the level of detail of the display of an image on the screen.

The touch-sensitive faceplate 18 of reduced dimensions may also be mounted on a lateral wall of the electronic apparatus 10, to allow control of ancillary functions of the electronic apparatus 10 such as the taking of photographs by a camera mounted on the apparatus.

Although terms such as “top”, “bottom”, etc. have been used to help describe the connector as it is illustrated, the connector can be used in any orientation.

What is claimed is:

1. A touch-sensitive faceplate (18) which includes a horizontal upper panel (32) with an upper face (32s) that can be contacted by a pointing element (30), a supporting frame (38), means (34) for locating the point (P) of contact of the pointing element (30) on the upper horizontal face (32s) of the upper panel (32), and means for detecting at least one control action consisting in applying a pressure (F1, F2), by means of the pointing element (30), of a value greater than or equal to a predetermined threshold value, independently of the location of the point of contact (P) on the upper face (32s) of the upper panel (32), wherein:
said means for detecting comprises a single element (48) forming a disengageable stop of the upper panel (32) in a high position relative to the supporting frame (38) that is capable of changing state to produce a mechanical impulse of a vertical principal orientation on the upper panel (32), while allowing the upper panel (32) to move generally downward relative to the supporting frame (38), when the value of the pressure (F2) is greater than or equal to the threshold value and that is transmitted to the pointing element (30) to generate a tactile sensation in response to the control action.

2. The touch-sensitive faceplate (18) as claimed in claim 1, wherein:
the disengageable stop (48) consists in a concave element, that is arranged vertically between a lower horizontal face (32i) of the upper panel (32) and a horizontal face opposite the supporting frame (38) and that is capable of collapsing by elastic deformation when the value of the pressure of the pointing element (30) is greater than or equal to the threshold value.

3. The touch-sensitive faceplate (18) as claimed in claim 1 wherein:
the disengageable stop (48) is arranged generally in line with the center of the upper panel (32).

4. The touch-sensitive faceplate (18) as claimed in claim 1, wherein:
the upper panel (32) is partly in upward abutment against the lower horizontal face (42i) of an upper horizontal wall (42) of the frame (38) under the effect of the control action and when the point of contact (P) is offset horizontally relative to the disengageable stop (48).

5. The faceplate as claimed in the claim 4, wherein:
the upper panel (32) is partly in abutment against one of at least three bearing points belonging to said lower face (42i) and arranged in a triangle, the disengageable stop (48) being situated inside this triangle.

6. The touch-sensitive faceplate (18) as claimed in claim 1, wherein:
said means for detecting comprises means (50) for returning the upper panel (32) to a high rest position.

7. The touch-sensitive faceplate (18) as claimed claim 1, wherein:
the detection means comprise a single sensor that is compressed between the upper panel (32) and a support plate of the upper panel (32).

8. The touch-sensitive faceplate (18) as claimed in claim 7, wherein:
the single sensor consists in an electric commutator that is capable of opening or closing an electric circuit under the effect of the control action.

9. The touch-sensitive faceplate (18) as claimed in claim 8 wherein:
the disengageable stop (48) and the detection means consist in a single electronic commutator that is arranged between the location means (34) and the frame (38).

10. The touch-sensitive faceplate (18) as claimed in claim 7, wherein:
the single sensor consists in a pressure sensor that is capable of determining the value of the pressure of the pointing element (30).

11. The touch-sensitive faceplate (18) as claimed in claim 10, wherein:
the location means (34) and the detection means consist in a single detection device, particularly of the resistive type, that covers the lower horizontal face (32i) of the upper panel (32).

12. The touch-sensitive faceplate (18) as claimed in claim 1, wherein:
the location means (34) comprise electric switches (54) that are distributed horizontally beneath the lower face (32i) of the upper panel (32), and each of which is associated with a predefined portion (56a, 56b) of the upper face (32s) of the upper panel (32).

13. The touch-sensitive faceplate (18) as claimed in claim 12, wherein:
the upper panel (32) is made of an elastically deformable material, and in that the detection means (34, 54) are arranged on the upper horizontal face (36s) of an intermediate support plate (36).

14. The touch-sensitive faceplate (18) as claimed in claim 1, wherein:
the horizontal upper face (32s) of the upper panel (32) comprises a series of bosses (70).

15. The touch-sensitive faceplate (18) as claimed in claim 12, wherein:
the upper face (36s) of the support plate (36) supports a series of electric connection elements (68) that are distributed evenly along the peripheral edge of the support plate (36).

16. The touch-sensitive faceplate (18) as claimed in claim 1 wherein:
said means for detecting comprises means for displaying information selectively on the upper panel (32).

17. The touch-sensitive faceplate (18) as claimed in claim 16, wherein:
said means for detecting comprises a display screen arranged beneath the upper panel (32).

18. The touch-sensitive faceplate (18) as claimed in claim 14, wherein:
said means for detecting comprises a layer of ink printed on the lower face of the upper panel (32), and a light-emitting film that covers the printed ink layer, that is capable of illuminating selectively certain zones of the printed ink layer.

19. The touch-sensitive faceplate (18) as claimed in claim 1, wherein:
the detection means is capable of detecting different control actions, each of which consists in applying by means of the pointing element (30) a pressure on the upper face (32s) of the upper panel (32) with a value greater than or equal to an associated threshold value.

20. The touch-sensitive faceplate (18) as claimed in claim 19 wherein:
said means for detecting comprises means for generating a mechanical impulse each time one of the control actions has been detected by the detection means.

21. An arrangement for the mounting of a touch-sensitive faceplate (18) as claimed in claim 1 wherein said faceplate lies on a horizontal upper face (72s) of an electronic component-carrying board (72), wherein:
the upper panel (32), the location means (34), the means for detecting the control action and the means (48, 52) for generating the mechanical impulse form a subassembly (78) that is mounted and attached on the upper face (72s) of the electronic component-carrying board (72) by elastic interlocking.

22. The arrangement as claimed in claim 21, wherein:
said subassembly (78) is mounted on the upper face (72s) of the component-carrying board (72) by means of an intermediate board (92).

23. The arrangement as claimed in the claim 22, wherein:
the intermediate board (92) carries electronic components (98) and a connector (96) for the electrical connection of the touch-sensitive faceplate (18) to the electronic component-carrying board (72).
